(19) United States
(12) Patent Application Publication
(10) Pub. No.: US 2018/0266958 A1
(43) Pub. Date: Sep. 20, 2018

(54) METHOD AND APPARATUS FOR IMAGING A SAMPLE

(71) Applicants: European Molecular Biology Laboratory, Heidelberg (DE); Deutsches Krebsforschungszentrum - Stiftung des öffentlichen Rechts, Heidelberg (DE)

(72) Inventors: Lars Hufnagel, Heidelberg (DE); Patrick Hoyer, Heidelberg (DE)

(21) Appl. No.: 15/460,517

(22) Filed: Mar. 16, 2017

(51) Int. Cl. G01N 21/64

(52) U.S. Cl. CPC G01N 21/6458; G01N 2021/6463; G01N 21/6402

(57) ABSTRACT

A method and apparatus for imaging an area of interest (22) of a sample (20) is disclosed. The sample (20) comprises a plurality of fluorophores (25). The method comprises illuminating (320) along an illumination path (40) the area of interest (22) and adjacent areas (27a, 27b) of the sample (20) with radiation at a first wavelength to excite the fluorophores (25), providing (330) along the illumination path (40) an illumination pattern with a minimum intensity in the area of interest to switch off the fluorophores (25) in the adjacent areas, and imaging (340) the area of interest (22) at a detection path, the to detection path being substantially perpendicular to the illumination path (40).

### FIELD OF THE INVENTION

The invention relates to a method and apparatus for imaging a sample.

### BACKGROUND TO THE INVENTION

Super-resolution far-field fluorescence microscopy is typically able to discern features in a sample that are smaller than the diffraction barrier of around 250 nm by making fluorophores in the sample transiently assume different states and thus highlight those features to which the fluorophores are conjugated. These different states are usually molecular “on” and “off” states between which the fluorophores differ in the ability to fluoresce. Prior art techniques, such as stimulated emission depleted (STED), exploit this property to induce the “on” and “off” states at defined positions in the sample. These prior art approaches employ this approach to apply a pattern of light in the form of a standing wave which drives all the fluorophores briefly to one of the states, except for those fluorophores positioned in a narrow area of interest within the sample. This means that, for a short detection period of time, those features from within the narrow area of interest in the sample can be discerned. For example, within the narrow area of interest some of the fluorophores are switched on and fluoresce (and can thus be imaged), whilst outside of this area of interest the fluorophores are off (or vice versa).

### PRIOR ART

A paper by Chmyrov et el, “Nanoscopy with more than 100,000 doughnuts”, Nature Methods, vol 10, no 8, 737-740, 2013, teaches the parallelisation of nanoscopy based on the principle called RESOLFT (reversible saturable optical fluorescence transitions) or nonlinear structured illumination, which result in two incoherently superimposed orthogonal standing light waves. The intensity minima of the resulting pattern act as ‘doughnuts’, providing isotropic resolution in the focal plane and making pattern rotation redundant. The authors of the paper used the technique to super-resolve living cells in 120 μm×100 μm-sized fields of view in less than 1 s using 116,000 such doughnuts.

### SUMMARY OF THE INVENTION

This document teaches a method for imaging an area of interest of a sample with a plurality of fluorophores. The method comprises illuminating, along an illumination path, the area of interest and adjacent areas of the sample with radiation at a first wavelength to excite the fluorophores. An illumination pattern with a minimum intensity is then provided to along the illumination patent in the area of interest to switch off the fluorophores in the adjacent areas. The area of interest is imaged at a detection path, whereby the detection path is substantially perpendicular to the illumination path.

In one aspect of the method, the illumination beam has two orthogonal phase components.

The illumination of the area of interest and the adjacent areas is in one aspect substantially a two-dimensional plane extending in the direction of the illumination path.

A further illumination pattern having a plurality of minimum intensities in a direction substantially perpendicular to the illumination path and the detection path can also be provided.

An apparatus for the imaging a sample employing this method is also described. The apparatus has a first laser emitting radiation at a first wavelength along an illumination path and illuminating the sample and a second laser emitting radiation at a second wavelength along the illumination path and providing an illumination pattern with a minimum intensity at the sample. An illumination objective lens is present in the illumination path and a detection objective lens for imaging fluoresced radiation from the sample is present along a detection path. The detection path is substantially perpendicular to the illumination path.

The apparatus can comprise further a phase delay device for creating from the radiation at a second wavelength an illumination beam having two orthogonal phase components. For example, the phase delay device can be a half-moon plate.

In one aspect, the apparatus further comprises a unit for providing a further illumination pattern having a plurality of minimum intensities in a direction substantially perpendicular to the illumination path and the detection path.

The apparatus further comprises a read-out laser for illuminating the sample at the to area of interest along the illumination path.

The apparatus and method taught in this document enable fast, inherently parallelized 3D imaging with a sub-diffraction axial resolution of areas of interest in a sample. The axial resolution of the apparatus is superior to that of any other light sheet fluorescence microscopy (LSFM) variants which do not implement molecular state transitions in the fluorophores, and therefore do not surpass the diffraction resolution limit (such as using Bessel-beam lasers or implementations based on structured illumination).

The inventors have found that a sample-dependent and power-dependent improvement by a factor of 5-12 can be achieved which clearly outperforms the previous STED-LS approach, in which a gain in axial resolution by a factor of <1.5 was reported for dye-filled particles, at much higher light doses, see Friedrich, M., Gan, Q., Ermolayev, V. Harms, G. S. STED-SPIM: Stimulated Emission Depletion Improves Sheet Illumination Microscopy Resolution. Biophys. J. 100, L43-L45 (2011).

The capability to create optical sections as the areas of interest and having approx. 100 nm thickness is similar to the axial resolving power of a typical total internal reflection fluorescence (TIRF) microscope. However, the TIRF microscope is restricted to applications close to a cover slip surface. The method of this disclosure teaches sub-diffraction axial resolution in any optical section used as the area of interest throughout the entire sample and can thus be applied to a broad range of cell-biological questions.

The method also teaches low off-switching intensities and thus enables live imaging of biological samples over extended time periods. Large fields of view are also possible. Due to the highly-parallelized readout, recordings can be comparatively fast. Since “off”-switching of the fluorophores in the sample and readout is performed at the same wavelength, any potential chromatic aberrations in thicker biological samples, e.g. in embryos, are avoided. Recordings with spectrally distinct fluorophores will in future allow co-localization studies in sub-diffraction volumes.

The method also enables a super-resolution along the lateral dimensions. The to apparatus employs independent beam paths for illumination and detection of the sample and the same concepts, which lead to conceptually diffraction-unlimited lateral resolution and utilize wide-field detection can also be applied.

### BRIEF DESCRIPTION OF THE FIGURES

The patent or application file contains at least one drawing executed in color. Copies of this patent or patent application publication with color drawing(s) will be provided by the Office upon request and payment of the necessary fee.

FIG. 1 shows a diagram of a microscope apparatus of this disclosure.

FIGS. 2A-D show a side view of a sample.

FIG. 3 shows a method of imaging the sample using the microscope apparatus.

FIG. 4 shows the results of the method for spherical HIV-1 particles.

FIG. 5 shows the results of the method for HeLa sample.

### DETAILED DESCRIPTION OF THE INVENTION

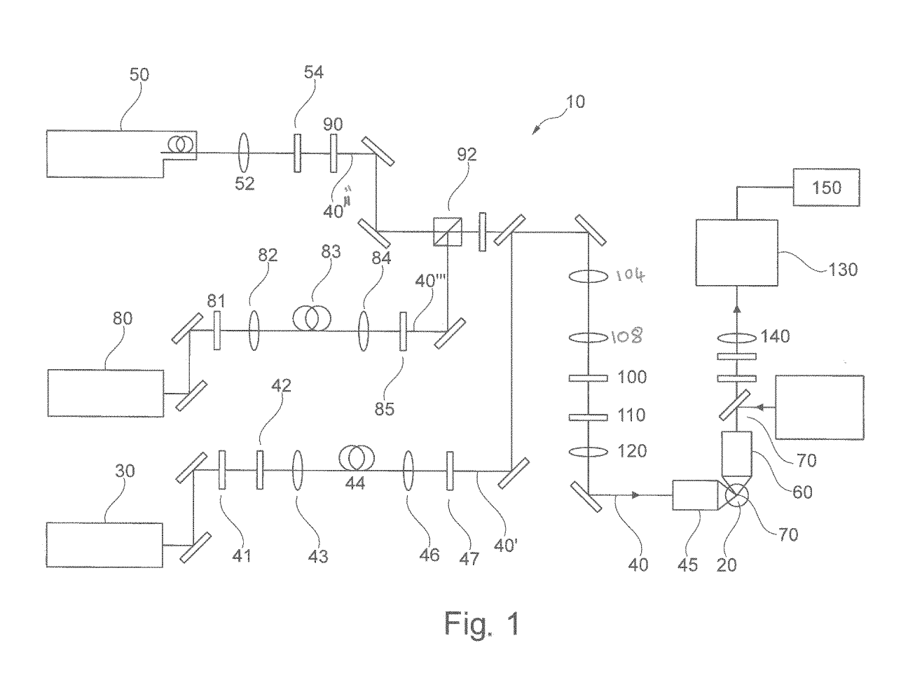

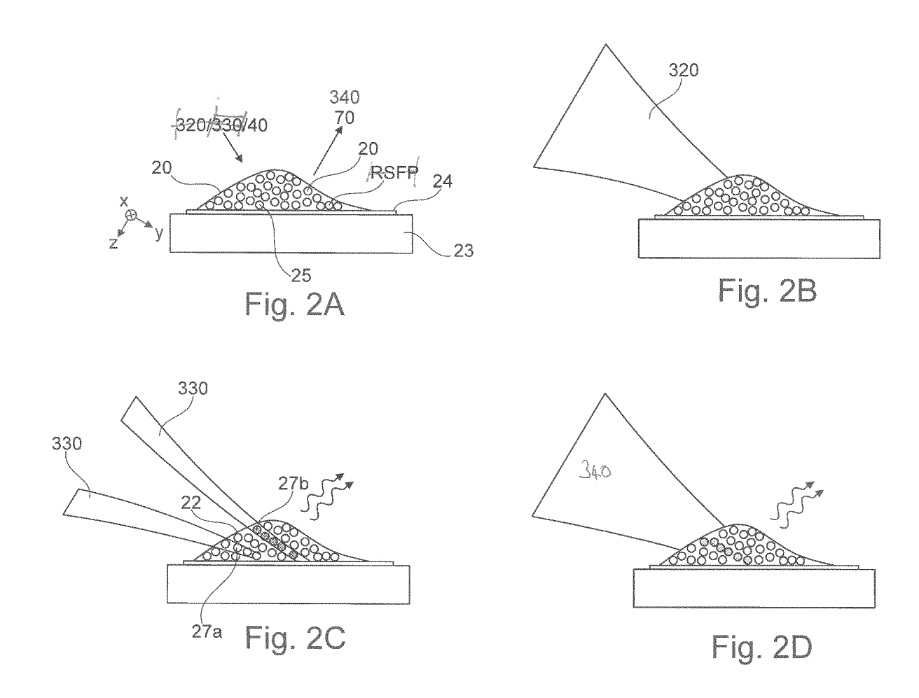

FIG. 1 shows a diagram of a microscope apparatus 10 for imaging a sample 20, which is shown in more detail in FIG. 2. The sample 20 comprises a plurality of fluorophores 25 and has an area of interest 22 (see FIG. 2C), which is to be imaged. The area of interest 22 is surrounded by neighbouring areas 27a and 27b, which also contain fluorophores 25, but which are not to be imaged in a current imaging step.

The microscope apparatus 10 has three lasers in FIG. 1. A first laser 30 emits radiation at a first wavelength along a first illumination path 40′ and a common illumination path 40. A second laser 50 emits radiation at a second wavelength along a second illumination path 40″ and the common illumination path 40. A third laser (also termed read-out laser) 80 also emits radiation at the second wavelength along a third illumination path 40′″ and the common illumination path 40. As will be explained later, the second laser 50 and the third laser 80 are not active at the same time and it would be possible to use a common laser for the second laser 50 and the third laser 80 and switch to between illumination paths.

The common illumination path 40 for all three of the lasers 30, 50, or 80 comprises a first filter 104 and a second filter 108 as well as a Glann-Thompson prism 100, a lambda half plate 110 and a cylinder lens 120. The Glann-Thompson prism 100 is used to “clean up” the polarisation of the light from the lasers and, in particular, to ensure that any variations in polarisation between the light in the common illumination path 40 is very small. The lamba half plate 110 is used to rotate the polarisation of the light in the common illumination path 40. The cylinder lens 120 focuses the light onto the back focal plane of the illumination objective lens 45 and is used to create a light sheet on the back focal plane of an illumination objective lens 45.

The illumination objective 45 has a low numerical aperture, typically in the range of 0.1 to 0.8, e.g. 0.3 and focuses the light in the form of a light sheet onto the sample 20. The sample 20 comprises a plurality of fluorophores 25, which fluoresce and the fluorescent light is detected by the detection objective lens 60 and passed to a CCD camera 130 through a tubular lens 240. The fluorophores 25 can by synthetic fluorophores, genetically encoded fluorophores or a combination of both. The fluorophores 25 used are reversibly switchable fluorescent proteins (RSFP). Suitable RSFPs include, but are not limited to yellow-green-emitting RSFPs, such as rsEGFP, rsEGFP2 and rsEGFP(N025S) The rs EGFP(N025S) RSFP has slower off-switching kinetecs than the other ones of the listed RSFPs, but offers more photons per unit time when in the on state.

The first laser 30 emits light at a wavelength of 405 nm in this example and is connected to the common illumination path 40 by the first illumination path 40′. The first illumination path 40′ comprises a first clean-up filter 41, a first lambda half plate 42, a first lens 43 with a focal length of 10 mm, a phase-maintaining fibre 44, a second lens 46 with a focal length of 16 mm and a second lambda half plate 47.

The third laser 80 emits light at a wavelength of 488 nm in this example and is connected to the common illumination path 40 by the third illumination path 40′″. The third illumination path 40′″ comprises a third lambda/2 plate 81, a third filter 82, a second to phase-maintaining fibre 83, a fourth filter 84 and a fourth half lambda plate 85.

The second laser 50 emits light at a wavelength of 488 nm in this example and is connected to the common illumination path 40 by the second illumination path 40″. The second illumination path 40″ comprises a fifth filter 52, a fifth lambda/2 plate 54, and a is half-moon phase plate 90. The half-moon phase plate 90 generates front the light from the second laser 50 two components, which have phases orthogonal to each other. A dichromic minor 92 merges the light from the second laser 50 and the third laser 80.

The fluoresced light is collected by a detection objective lens 60 and passed along a detection path 70 through filters and a tubular lens 140 to a camera 130. The camera 130 passes the data to a processor 150 which creates the images.

FIGS. 2A to 2D shows a cross-section of the sample 20 and shows the direction of the common illumination path 40 in the y-direction as well as the detection path 70 in the x-direction. The sample 20 comprises the plurality of the fluorophores 25 and has an area of interest 22 to be imaged as well as adjacent areas 27a and 27h located above and below the area of interest 22 (see FIG. 2C).

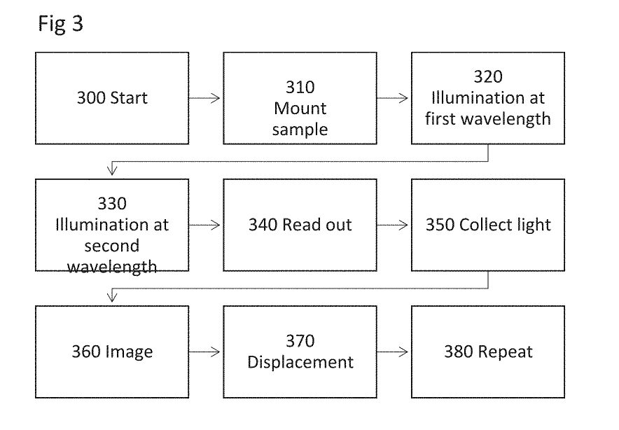

FIG. 3 shows the method of imaging of the invention. The method starts at step 300. The sample 20 is first mounted on a cover slip 24 which is located on a movable stage 23 in a viewing chamber in step 310. In step 320 the sample 20 is illuminated with light at a first wavelength. In this non-limiting example, the first wavelength is 405 nm with light from the first laser 30. The fluorophores 25 in the sample 20 are switched to the “on” state with the 405 nm light, as can be seen in FIG. 2B.

The sample 20 is then illuminated in step 330 with light of a second wavelength. In this non-limiting example, the second wavelength is blue light of 488 nm and this blue light switches the “on”-state fluorophores 25 to the “off” state and also elicits fluorescence. The fluorophores 25 used in this non-limiting example emit at around 510 nm. The blue light has a minimum intensity at the area of interest 22 of the sample 20. This creates a section of “on”-state fluorophores 25 of sub-diffraction thickness by switching those fluorophores in the vicinity of this plane—which is made to coincide with the detection focal plane—to the “off” state in the adjacent areas 27a, 27b as seen in FIG. 2C. This “of”-switching pattern is generated by the half-moon phase plate 90 placed in the collimated off-switching beam from the second laser 50. The polarization of the electric field component of this off-switching beam coincides with the plane of the light sheet.

In the next step 340 of the method, the remaining “on”-state fluorophores 25 in the is area of interest 22 are read out by the third laser 80 of the same wavelength, as shown in FIG. 2D. This third laser 80 also switches the fluorophores 25 “off” again. The third laser 80 emits light with the same wavelength of the first laser 30, as noted above.

The detection objective lens 60 has a high numerical aperture the range of e.g. 0.8 to 1.0) and collects in step 350 the fluorescence signals from the region of interest 22 in the sample in an inherently parallelized manner. The tubular lens 140 images in step 360 the collected fluorescence signal onto an sCMOS camera chip 130 (lateral sampling of 108.3 nm). The images are recorded in step 370 by displacing (scanning) the platform 24 with the mounted cover slip 24 and the sample 20 at an angle of 30° with respect to the illumination axis 40,

The above acquisition cycle is thus repeated in step 380 for each section of the sample 20. The step size of the movable stage 23 defining the axial sampling of the specimen. The Rayleigh range along the illumination axis, the width of the light-sheets and the maximal scan range of the movable stage 23 determine the detectable volume of the sample 20.

### Experimental Details

A living specimen 20 expressing rsFPs 25 was grown on the cover slip 24 mounted on the movable stage 23. The living specimen 20 is illuminated in the y-direction perpendicular to the detection axis (z-axis). The rsFPs fluororphores 25 are switched only in a thin diffraction-limited section, from their initial “off” state (unfilled dots) to the “on” state (white dots) by an activating light-sheet (see FIG. 2C). None of the fluorophores 25 outside the illuminated volume is affected by the laser light.

A light sheet featuring a central zero-intensity plane effectively switches “off” the to activated rsFPs 25 in step 330, as is shown in FIG. 2C above and below the detection focal plane (x-y). For the negative-switching fluorophores 25, this is a competing process to fluorescence. If the “off”-switching light intensities above the threshold intensity of the fluorophores 25 are applied, only those ones of the fluorophores 25 within a slice of sub-diffraction thickness remain activated. These activated fluorophores 25 can be read out by the third light sheet from the third laser 80 in step 340 and the collected light in step 350 contributes to the construction of the image in step 360. The movable stage 23 is displaced in step 370 to the next position in the scanning sequence for repetition in step 380 of another illumination cycle. The light sheets impinge on the cover slip 24 at an angle of 30°.

Optical Setup. The apparatus 10 uses laser beams of three fast-switching continuous-wave (CW) diode lasers 30, 50 and 80, which are formed to light sheets in the focal plane of the water-dipping illumination objective lens 45 (CFI Plan Fluor 10XW, Nikon, NA 0.3). Light of a UV laser 30 (iBeam Smart 405-60, Toptica Photonics) with a nominal wavelength of 405 nm and maximal power of 60 mW activates in step 320 the fluorophores 25 in the sample 20. The “off”-switching light pattern is generated by the second laser 50 (iBeam Smart PT488-50, Toptica. Photonics, 488 nm, 50 mW). After the “off”-switching process in step 330, the remaining activated fluorophores 25 are read out in step 340 using the third laser 80 (LuxX 488-60, Omicron-Laserage Laserprodukte, 488 nm, 60 mW) with the same nominal wavelength.

The lasers 30, 50 and 80 are spectrally and spatially filtered with narrow handpass filters (FF02-482/18-25, FF01-406/15-25, Semrock) and polarization maintaining single-mode fibers (M460-HP, Thorlabs. At the fiber output, the beam diameter of each of the lasers 30,50 or 80 is independently controlled with achromatic doublets (fL1=13 mm, fL4=13 mm, fL5=16 mm) to compensate for potential longitudinal chromatic aberrations in the focal plane. The off-switching intensity pattern is generated by the half-moon phase plate 90 which is placed on the optical axis in the illumination path 40″ of the collimated off-switching laser beam from the second laser 30. The half-moon phase plate 90 comprises two quartz blocks mounted in parallel on a multi-axis positioner (LP-1A, Newport Corporation, Irvine, Calif.) which tilts the blocks with respect to each other to generate a phase difference between the beam halves. The modified beam is subsequently combined with the beam path of the third laser 80 by a 50:50 beam splitting cube (BS013, Thorlabs),

The dichroic mirror 92 (Di02-R442, Semrock) merges the expanded UV beam from the second laser 50 and the third laser 80. A common beam expander consisting of two achromatic lenses (fL8=60 mm, fL9=200 mm) adjusts the beam widths to the pupil diameter of the illumination objective lens 45. The polarization state of the laser beams for is activation, excitation and switch-off is adjusted by the Chan-Thompson prism 100 (PGT 1.10, B. Halle) and the half lambda plate 110. The cylindrical lens1 40 (fCL=150 mm) focuses the collinear beams into the back-aperture of the illumination objective lens 45, which generates a light-sheet (LS) at an angle β=30° with respect to the horizontal plane. The detection objective lens 60 (CFI Apo 40XW NIR, Nikon, NA 0.8) is oriented perpendicularly to the x-y plane of the light sheet and thus has an angle of 60° with respect to the cover slip 24. These angles were chosen such that, theoretically, any commercially available water-dipping detection objective lens today can use its full aperture for collection of the fluorescence light. Additionally, undesired artifacts potentially caused by direct reflections of the illumination laser light from the surface of the cover slip surface 24 are avoided.

Both the illumination objective lens 45 and the detection objective lens 60 are held by a monolithic objective mount unit which is connected to a standard breadboard by a kinematic mount consisting of a system of balls, vee-grooves and magnets, and can be lifted for conveniently replacing the sample 20 or the illumination objective lens 45 or the detection objective lens 60. The illumination objective lens 45 and the detection objective lens 60 can be moved along their optical axes by linear stages (M-SDS40 Precision, Newport Corporation). The relative lateral position of the illumination objective lens 45 and the detection objective lens 60 can be precisely adjusted with a home-build flexure design. The detection objective lens 60 is part of a wide-field microscope comprising two identical emission band-pass filters (FF03-525/50-25, Semrock) and a tube lens (fTL=300 nun, Nikon) focusing the fluorescence onto a 4-megapixel (2048×2048 pixels) sCMOS camera 130 (ORCA-Flash4.0 V2, Hamamatsu). The focal length of the tubular lens 140 was chosen such that the 6.5 μm square pixels on the camera 130 projected to a sampling size of 108.3 nm in the specimen space. For imaging speed, the camera 130 is rotated by β so that the readout lines of the sensor are aligned along the x-direction. A cropped FOV along the v-direction thus considerably shortens the required readout time and increases the to overall frame rate.

For imaging, a standard round glass cover slip 24 with a diameter of 5 mm is clipped onto the movable stage 23 at the bottom of a medium-filled specimen chamber made of biocompatible poly etheretherketone (PEEK), which features a comparably low linear thermal expansion coefficient and excellent resistance to a wide range of chemicals. On one side of the specimen chamber, a glass window is inserted, through which the light sheets can be imaged from the side. To accurately and reproducibly align the longer horizontal axis of the specimen chamber relative to the scan direction, the lateral movement of the specimen chamber is kinematically constrained by a system of balls, vee-grooves and magnets. A piezoelectric stage (P-625.1CL, Plfiera Piezo Linear Stage, Physik Instrumente) with a minimal step size of 10 nm and a total range of 500 μm scans the sample 20 in steps through the static light sheets. A preset step response time of 102 ms/μm assures a stable scan throughout the measurement. The scanner is attached to the movable stage 23 (562 ULTRAlign Precision, Newport Corporation), with which the sample 20 can be centered in the FOV of detection.

Image acquisition and representation. All electronic devices in the setup, i.e., lasers, camera and the stage scanner are controlled by custom software composed in LabVIEW. An FPGA (NI PCIe-7841R, National Instruments) simultaneously sends a pre-set sequence of analog and digital signals to the devices in order to assure synchronization of the scanning process and image acquisition. For a single image, a sequence of three successive laser triggers is used: First, molecules are switched to the “on” state (“activation”) with a LS at 405 nm in step 320. Then a short illumination pause of 2 ms is followed by an “off”-switching pulse in step 330, which is typically longer than the activation period. After another pause of 2 ms, signal for the image is acquired in step 340 while illuminating the sample with the excitation laser at 488 nm in step 350, and stored on a separate camera PC in step 360. Finally, the movable stage 23 moves to the next positionin step 380 where another illumination cycle starts. By translating the scanner only in the horizontal plane, the sample 20 always remains positioned at the minimal light-sheet waist. This ensures that the sample 20 is imaged with the same axial resolution at any scan position. In principle, a very large area, up to the maximal scanning range of the scanner, can be imaged with this to method.

Image data recorded typically do not require any post-processing such as fitting, denoising or restoration. The recorded images are affinely transformed to the coordinate system of the light sheet using a custom Matlab script. It should be noted that this procedure re-arranges the acquired data without changing its raw character.

Sample Preparation. HIV-1 Particles on Glass.

A standard round glass cover slip 24 was cleaned with absolute ethanol and air-dried. A drop of HIV-1 particles diluted in PBS was incubated on the cover slip 24 for 10 minutes. The cover slip 24 was then carefully rinsed with phosphate buffered saline (PBS). HIV-1 samples were imaged at room temperature in FluoroBrite™ DMEM medium.

Sample Preparation: Mammalian Cell Culture.

A pool of transiently transfected and subsequently FACS-sorted HeLa. Kyoto cells expressing keratin-19 fused with rsEGFP(N205S) was grown DMEM containing phenol red, L-glutamine, and high glucose supplemented with 10% FBS, 1% sodium pyruvate and geneticist selective antibiotic at a final concentration of 1 mg/ml. For live-cell experiments, 1×105 cells were seeded on a round cover slip 24 in a 24-well and grown for 24 hours. Three hours prior to imaging, the selection medium was exchanged by DMEM containing HEPES (but no phenol red, to reduce unwanted background caused by phenol red uptake). Immediately before imaging, the cover slip 24 was washed with PBS. The cells were imaged at room temperature in FluoroBrite™ DMEM medium.

U2OS cells were grown in McCoy's 5A modified medium containing phenol red, L-glutamine, high glucose, and bacto-peptone supplemented with 1% FCS, 1% glutamine, 1% non-essential amino acids, and 1% penicillin streptomycin. For live-cell imaging, 4×104 cells were grown on a round cover slip 24 placed in a 24-well for 24 hours. Then, the cells were transiently transfected with the construct NUP214-3xrsEGFP(N205S) and FugeneHD® according to the manufacturer's guidelines. After an incubation time of 72 hours, the growth medium was exchanged by DMEM containing HEPES but no phenol red. Immediately before imaging, the cover slip 24 was washed three times with PBS. The cells were imaged at room temperature in FluoroBrite™ DMEM medium. In order to obtain the NUP214-3x-rsEGFP(N205S) construct, the DNA of the NUP214-gene was amplified per PCR from a pNUP214-EGFP plasmid and subcloned into a backbone that was obtained before by introducing a triple-rsEGFP(N205S) into a pmEGFP-N1 vector.

### is Results

### EXAMPLE 1

### HIV-1 Particles

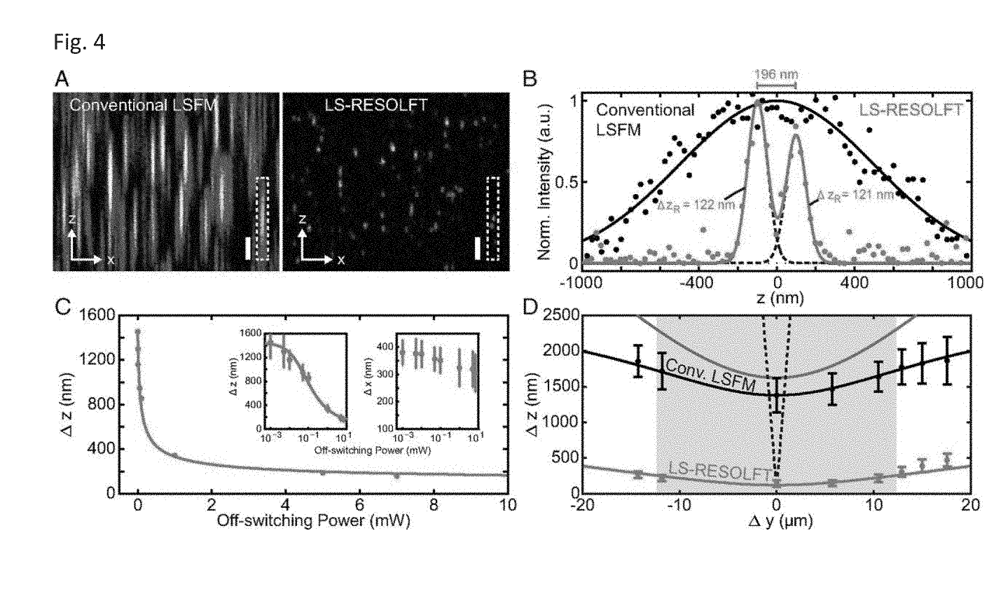

The resolving power of the apparatus was tested using spherical HIV-1 particles as the sample 20 and results are shown in FIG. 4. The sample had more than a thousand rsEGFP2 proteins as the fluorophores 25.

FIG. 4 shows the characterization of the method of the current document with spherical HIV-1 particles, in comparison with the conventional LSFM mode. FIG. 4A shows an x-z cross-section through a typical 3D image stack of HIV-1 particles attached to a glass coverslip clearly shows the improvement in z resolution enabled by the method. It will be noted that pixels correspond to 108.3 nm in x and 25 nm in z, respectively (total image size: 24×4 μm2), (Scale bar width and height, 500 nm) FIG. 4B shows the pixel intensity line profile along the z direction in a marked region in A (dashed box) for the method (white dots) in comparison with conventional LSFM (black dots), with single (upper line) and double (lower line) Gaussian fits to the data. The FWHMs of single Gaussian fits (dashed line) to the data using the method are far below the (axial) diffraction limit. FIG. 4C shows the dependence of the resolving power Δz on the off-switching laser power. For a fixed off-switching time of 30 ms, the average axial FWHMs of the HIV-1 particles imaged using the present method were determined for various powers of the switch-off light bounding the axial zero-intensity plane. Mean FWHM values are plotted versus off-switching power in the back-focal plane of the illumination objective (dots). The fit (line) to the data confirms the inverse scaling with the square root of the applied intensity. Lateral (x-y) FWHM dependence on off-switching power is shown in shown in FIG. 4D. At several positions along the illumination axis of the LSs, the average axial FWHM of the HIV-1 images were determined. The average value of Δz together with the SD is plotted versus the measured value of Δy for conventional LSFM (upper data points) to and the method (lower data points). From a fit to the conventional LSFM data (black line), the experimentally realized (diffraction-limited) illumination profile is inferred (topmost line) for an illuminating Gaussian LS and a (near-) Gaussian axial detection profile. The FOV (gray box) of the microscope is then defined by the increase in waist by 2⁻√2-fold to both sides. For reference, the FWHM beam waist of a theoretical Gaussian LS with the same minimum value as achieved by the method is plotted versus Δy (dashed line). It will be seen that the method substantially extends the available FOV along the y direction.

It will be seen that, for a sufficiently high “off”-switching intensity, the axial resolution of the apparatus is increased below the diffraction limit. The FWHM of a Gaussian fit to the axial line profile through a single virion is reduced from a value of 1522 nm for diffraction-limited traditional SPIM microsopy to 124 nm using the system of the current document. FIG. 4A shows the pixel intensity along a line in the z-direction though the same virus particle. The x-position of the line profiles in FIG. 4A is marked with white arrows in the images of FIG. 4A. The FWHMs of Gaussian fits to the data reveal an improvement in axial resolution by a factor of more than 12 compared to standard SPIM microscoopy. If the average HIV-1 particle size of 120-130 nm is taken into account, a thickness of <100 nm (FWHM) is obtained. In a dense sample, single ones of the virions are clearly separable in the image at sub-diffraction distances, whereas they are not separable in the conventional SPIM microscopy.

The theoretically predicted square root dependency of axial resolution on the “off”-switching power was experimentally confirmed (see FIG. 4D). The axial resolution is not limited conceptually, but merely by the available “off”-switching power and the photophysical properties of the fluorophores 25. Designed for axial resolution improvement, the results presented in FIG. 4A additionally suggest a moderate (up to ˜15%) decrease in extracted particle diameters along the lateral direction (at maximal switch-off power). This is due to better definition of the structure owing to improved image contrast (clarity) and should not be assigned to a true resolution increase in the strict formal sense. Importantly, FWHM values measured at different positions along the illumination axis indicate that the Rayleigh range of the apparatus is sufficiently long to uniformly switch “off” the fluorophores 25 in an entire section of a biological cell (as to shown in FIG. 4x). At the same time, the advantage of reduced photobleaching typical for standard SPIM microscopy, and benefitting long-term acquisition of thick samples, is also conserved in the apparatus of the current disclosure.

### EXAMPLE 2

### HeLa Cells

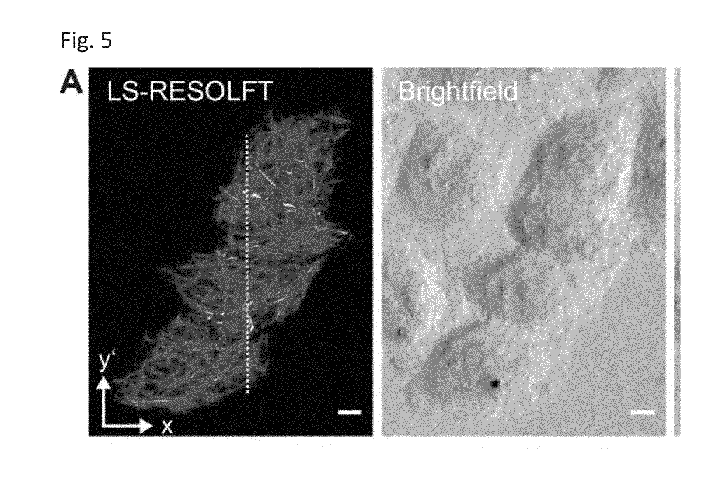

The imaging capabilities of the apparautson the cytoskeleton of living HeLa cells was also carried out and is shown in FIG. 5. The structural protein keratin-19 was labeled by fusion of the recently developed fluorophore rsEGFP variant rsEGFP(N205S), which has slower “off”-switching kinetics than other rsEGFPs but, at the same time, offers more photons per unit time when in the “on” state. After activation at 350 μW for 10 ms, the double-sheeted “of”-switching beam (6.9 mW) was applied for 100 ms, followed by readout for 60 ms at 150 μW. In order to directly visualize the improvement in resolution, a conventional SPIM image is subsequently taken at the same scan position (i.e., activated and read out with the same light doses and exposure times as for the the image using the apparatus of this disclosure, yet without “off”-switching I step 330). The imaging of NUP214, a constituent protein of the nuclear pore complex, fused to three rsEGFP(N205S) proteins in living N2OS cells shows similar gains in resolution.

### REFERENCES

1. Hell, S. W. Toward fluorescence nanoscopy. Nat. Biotechnol. 21, 1347-1355 (2003).
2. Hell, S. V. Microscopy and its focal switch. Nat. Methods 6, 24-32 (2009).
3. Rust, M. J., Bates, M. & Zhuang, X. W. Sub-diffraction-limit imaging by stochastic optical reconstruction microscopy (STORM). Nat. Methods 3, 793-795 (2006).
4. Betzig, E. et al. Imaging Intracellular Fluorescent Proteins at Nanometer Resolution, Science 313, 1642-1645 (2006).
5. Hess, S. T., Girirajan, T. P. K. & Mason, M. D. Ultra-High Resolution Imaging by Fluorescence Photoactivation Localization Microscopy. Biophys. J. 91, 4258-4272 (2006).
6. Hell, S. W. & Wichmann, J. Breaking the diffraction resolution limit by stimulated emission: stimulated-emission-depletion fluorescence microscopy. Opt. Lett. 19, 780-782 (1994).
7. Hofmann, M., Eggeling, C., Jakobs, S. & Hell, S. W. Breaking the diffraction harrier in fluorescence microscopy at low light intensities by using reversibly photoswitchable proteins. Proc. Natl. Acad. Sci. U.S.A. 102, 17565-17569 (2005).
8. Grotjohann. T. et al. Diffraction-unlimited all-optical imaging and writing with a photochromic GFP. Nature 478, 204-208 (2011).
9. Brakemann, T. et al. A reversibly photoswitchable GFP-like protein with fluorescence excitation decoupled from switching. Nat. Biotechnol. 29, 942-947 (2011).
10. Grotjohann, T, et al. rsEGFP2 enables fast RESOLFT nanoscopy of living cells. eLife 1, (2012).
11. Gustafsson, M. G. L. Nonlinear structured-illumination microscopy: wide-field fluorescence imaging with theoretically unlimited resolution. Proc. Natl. Acad. Sci. U.S.A. 102, 13081-13086 (2005).
12. Schwentker, M. A. et al. Wide-field subdiffraction RESOLFT microscopy using fluorescent protein photoswitching. Microsc. Res. Tech. 70, 269-280 (2007).
13. Chmyrov, A. et al. Nanoscopy with more than 100,000 ‘doughnuts’. Nat. Methods (2013). doi:10.1.038/nmeth.2556
14. Huisken, J., Swoger, J., Bene, F. D., Wittbrodt, J. & Stelzer, E. H. K. Optical Sectioning Deep Inside Live Embryos by Selective Plane Illumination Microscopy. Science 305, 1007-1009 (2004).
15. Krzic, U., Gunther, S., Saunders, T. E., Streichan, S. J. & Hufnagel, L. Multiview light-sheet microscope for rapid in Coto imaging. Nat. Methods 9, 730-733 (2012).
16. Tomer, R., Khairy, K., Amat, F. & Keller, P. J. Quantitative high-speed imaging of entire developing embryos with simultaneous multiview light-sheet microscopy. Nat. Methods (2012). doi:10.1038/n.meth.2062
17. Keller, P. J. & Stelzer, E. H. K. Quantitative in vivo imaging of entire embryos with to Digital Scanned Laser Light Sheet Fluorescence Microscopy. Curr. Opin. Neurohiol. 18, 624-632 (2008).
18. Engelbrecht, C. J. & Stelzer. E. H. Resolution enhancement in a light-sheet-based microscope (SPIM). Opt. Lett 31, 1477-1479 (2006).
19. Capoulade, J., Wachsmuth, M., Hufhagel, L. & Knop, M. Quantitative fluorescence imaging of protein diffusion and interaction in living cells. Nat. Biotechnol. 29, 835-839 (2011).
20. Fahrbach, F. O., Simon, P. & Rohrbach, A. Microscopy with self-reconstructing beams, Nat. Photonics 4, 780-785 (2010).
21. Planchon, T. A. et al. Rapid three-dimensional isotropic imaging of living cells using Bessel beam plane illumination. Nat. Methods 8, 417-423 (2011).
22. Gao, L. et al. Noninvasive Imaging beyond the Diffraction Limit of 3D Dynamics in Thickly Fluorescent Specimens. Cell 151, 1370-1385 (2012).
23. Durnin, J., Eberly, J. H. & Miceli, J. J. Comparison of Bessel and Gaussian beams. Opt. Lett. 13, 79-80 (1988).
24. Friedrich, M., Gan, Q., Ermolayev, V. & Harms, G. S. STED-SPIM: Stimulated Emission Depletion Improves Sheet Illumination Microscopy Resolution. Biophys. J. 100, L43-L45 (2011).

### REFERENCE NUMERALS

10 Apparatus
20 Sample
22 Area of interest
23 Movable stage
24 Cover slip
25 Fluorophores
27a, 27b Neighbouring areas
30 First laser
40 Illumination path
41 First clean-up filter
42 First lambda half plate
43 First lens
44 Phase-maintaining fibre
45 Illumination objective lens
46 Second lens
47 Second lambda half plate
50 Second laser
52 Fifth filter
54 Fifth lambda/2 plate
60 Detection objective lens
70 Detection path
80 Read-out laser
81 Third lambda/2 plate
82 Third filter
83 Second phase maintain fibre
84 Fourth filter
85 Fourth lambda/2 plate
90 Half-moon phase plate
92 Dichromic mirror
100 Glan-Thompson prism
104 First filter
108 Second filter
110 Lambda half plate
120 Cylinder lens
130 Camera
140 Tubular lens
150 Processor

1. A method for imaging an area of interest (22) of a sample (20), wherein the sample (20) comprises a plurality of fluorophores (25), the method comprising:
illuminating (320) along an illumination path (40) the area of interest (22) and adjacent areas (27a, 27b) of the sample (20) with radiation at a first wavelength to excite the fluorophores (25);
providing (330) along the illumination path (40) an illumination pattern with a minimum intensity in the area of interest to switch off the fluorophores (25) in the adjacent to areas;
imaging (340) the area of interest (22) at a detection path, the detection path being substantially perpendicular to the illumination path (40).

2. The method of claim 1, wherein the providing of the illumination path (40) comprises providing an illumination beam having two orthogonal phase components.

3. The method of claim 1, wherein the illumination of the area of interest (22) and the adjacent areas (27a, 27b) is substantially a two-dimensional plane extending in the direction of the illumination path (40),

4. The method of claim 1, further comprising providing a further illumination pattern having a plurality of minimum intensities in a direction substantially perpendicular to the illumination path (40) and the detection path.

5. The method of claim 1, wherein the first wavelength is about 405 nm.

6. The method of claim 1, wherein the second wavelength is about 488 mm

7. The method of claim 1, further comprising combing images of a plurality of areas of interest (22) to form a final image.

8. An apparatus (10) for the imaging a sample (20), wherein the sample (20) comprises a plurality of fluorophores (25), the apparatus (10) comprising:
a first laser (30) emitting radiation at a first wavelength along an illumination path (40) and illuminating the sample (20);
a second laser (50) emitting radiation at a second wavelength along the illumination path (40) and providing an illumination pattern with a minimum intensity at the sample (20);
an illumination objective lens (45) in the illumination path (40); and
a detection objective lens (60) for imaging fluoresced radiation from the sample to (20) along a detection path (70), wherein the detection path (70) is substantially perpendicular to the illumination path (40).

9. The apparatus (10) of claim 8, further comprising a phase delay device (90) for creating from the radiation at a second wavelength an illumination beam having two orthogonal phase components.

10. The apparatus (10) of claim 9, wherein the phase delay device is a half-moon plate (90).

11. The apparatus (10) of claim 8, further comprising an Glann-Thompson prism (100) in the illumination path (40).

12. The apparatus of claim 8, further comprising a lambda half plate (110) in the illumination path (40).

13. The apparatus of claim 8, further comprising a cylinder lens (120) in the illumination path (40).

14. The apparatus (10) of claim 8, further comprising a unit for providing a further illumination pattern having a plurality of minimum intensities in a direction substantially perpendicular to the illumination path (40) and the detection path (70).

15. The apparatus (10) of claim 8, further comprising a read-out laser (80) for illuminating the sample (20) at the area of interest (22) along the illumination path (40).

16. The apparatus (10) of claim 8, further comprising a recording device (130) connected to the detection objective lens (60).
